(19) United States
(12) Patent Application Publication
(10) Pub. No.: US 2025/0293426 A1
(43) Pub. Date: Sep. 18, 2025

(54) CIRCULARLY POLARIZED ANTENNA AND WEARABLE ELECTRONIC DEVICE

(71) Applicant: GUANGDONG COROS SPORTS TECHNOLOGY CO., LTD, Dongguan (CN)

(72) Inventor: Xianwei SHI, Dongguan (CN)

(21) Appl. No.: 19/226,873

(22) Filed: Jun. 3, 2025

Related U.S. Application Data
(63) Continuation of application No. PCT/CN2023/122808, filed on Sep. 28, 2023.

(51) Int. Cl. H01Q 1/27; H01Q 1/36; H01Q 1/48; H01Q 9/04

(52) U.S. Cl. CPC H01Q 1/273; H01Q 1/36; H01Q 1/48; H01Q 9/0492

(57) ABSTRACT

Provided are a circularly polarized antenna and a wearable electronic device. The circularly polarized antenna includes a first arc-shaped radiator, an arc angle of the first arc-shaped radiator is greater than or equal to 170 degrees and smaller than or equal to 190 degrees, a feeding point is provided in a central region of the first arc-shaped radiator, the feeding point is configured in electrical connection with a position determination element, and the first arc-shaped radiator is configured to receive a first circularly-polarized signal. The circularly polarized antenna provided in the embodiments of this application utilizes a first arc-shaped radiator to form the circularly polarized antenna, eliminating the need to fabricate a complete annular radiator, which reduces the length of the antenna and is conducive to the miniaturization design of the circularly polarized antenna.

### CROSS-REFERENCE TO RELATED APPLICATIONS

This application claims priority to and is a continuation of International Application No. PCT/CN2023/122808, filed on Sep. 28, 2023, the entire content of which is incorporated herein by reference.

### FIELD OF TECHNOLOGY

The following relates to the field of antenna technology, more particularly to a circularly polarized antenna and a wearable electronic device.

### BACKGROUND

With the rapid development of wireless communication terminal technology, wearable electronic devices have appeared in people's sight. A circularly polarized antenna for receiving circularly-polarized signals is arranged inside the wearable electronic device, so that the wearable electronic device has a positioning function.

The circularly polarized antenna in the existing wearable electronic device is arranged on a watch ring. For the non-metallic watch ring, a complete metal ring must be fabricated on the watch ring to form the circularly polarized antenna. However, due to the compact size and complex internal environment of wearable electronic devices, the design of circularly polarized antennas presents significant challenges.

### SUMMARY

One of the objectives of the embodiments of this application is to provide a circularly polarized antenna and a wearable electronic device, which can solve the problem of high design difficulty for circularly polarized antennas in wearable electronic devices.

In accordance with a first aspect, an embodiment of the present application provides a circularly polarized antenna, which includes a first arc-shaped radiator, an arc angle of the first arc-shaped radiator being greater than or equal to 170 degrees and smaller than or equal to 190 degrees. A feeding point being provided in a central region of the first arc-shaped radiator, and the feeding point is configured in electrical connection with a position determination element. The first arc-shaped radiator being is configured to receive a first circularly-polarized signal.

In a possible implementation of the first aspect, the first arc-shaped radiator is also provided with a first grounding point, and the first grounding point is provided in the central region of the first arc-shaped radiator, and an arc angle between the feeding point and the first grounding point along a circumferential arc of the first arc-shaped radiator is smaller than a preset angle.

In a possible implementation of the first aspect, the preset angle is greater than zero degrees and smaller than 45 degrees.

In a possible implementation of the first aspect, the circularly polarized antenna also includes a frequency modulation component, the frequency modulation component is electrically connected to the first arc-shaped radiator, the frequency modulation component is configured to adjust a frequency of a signal received by the first arc-shaped radiator, to enable the first arc-shaped radiator to receive the first circularly-polarized signal of a first target frequency.

In a possible implementation of the first aspect, the frequency modulation component includes an inductor, a first end of the inductor is electrically connected to the first arc-shaped radiator, and a second end of the inductor is grounded;
and/or,
the frequency modulation component includes a capacitor, a first end of the capacitor is electrically connected to the first arc-shaped radiator, and a second end of the capacitor is grounded.

In a possible implementation of the first aspect, the circularly polarized antenna also includes a second arc-shaped radiator, the second arc-shaped radiator and the first arc-shaped radiator are arranged at an interval. The second arc-shaped radiator and the first arc-shaped radiator are located on a same circumference, and an arc length between a second end of the second arc-shaped radiator and a first end of the first arc-shaped radiator is smaller than an arc length between a first end of the second arc-shaped radiator and a second end of the first arc-shaped radiator. The second arc-shaped radiator is provided with a second grounding point. The second arc-shaped radiator and the first arc-shaped radiator are configured to receive a second circularly-polarized signal.

In a possible implementation of the first aspect, the second arc-shaped radiator and a first radiation portion on the first arc-shaped radiator are configured to receive the second circularly-polarized signal. The first radiation portion includes a radiator between the feeding point and the first end of the first arc-shaped radiator.

In a possible implementation of the first aspect, an arc angle between the first end of the first arc-shaped radiator and the second end of the second arc-shaped radiator along the circumference is greater than or equal to 10 degrees and smaller than or equal to 30 degrees.

In a possible implementation of the first aspect, the second grounding point is arranged at a second end portion of the second arc-shaped radiator.

In accordance with a second aspect, an embodiment of the present application provides a wearable electronic device, which includes a housing, a position determination element, and a circularly polarized antenna described in any one of the first aspects. The housing includes a bottom wall and a side wall connected to the bottom wall, the circularly polarized antenna is arranged on the side wall, and the position determination element is coupled with the circularly polarized antenna;

The circularly polarized antenna is configured to receive the first circularly-polarized signal and transmit the first circularly-polarized signal to the position determination element, and the position determination element is configured to determine a current geographic location according to the first circularly-polarized signal.

The circularly polarized antenna provided by the embodiments of the present application includes a first arc-shaped radiator, an arc angle of the first arc-shaped radiator is greater than or equal to 170 degrees and smaller than or equal to 190 degrees, a feeding point is arranged in a central region of the first arc-shaped radiator, the feeding point is configured in electrical connection with a position determination element, and the first arc-shaped radiator is configured to receive the first circularly-polarized signal.

The circularly polarized antenna provided in the embodiments of this application utilizes a first arc-shaped radiator to form the circularly polarized antenna, eliminating the need to fabricate a complete annular radiator, which reduces the length of the antenna and is conducive to the miniaturization design of the circularly polarized antenna. The first arc-shaped radiator can be flexibly designed within wearable electronic devices, which reduces the design difficulty of the circularly polarized antenna.

### BRIEF DESCRIPTION OF THE DRAWINGS

In order to illustrate the technical schemes in the embodiments of the present application more clearly, the following will briefly introduce the drawings required for use in description of the embodiments. Obviously, the drawings described below are merely some embodiments of the present application. For ordinary technicians in this field, other drawings may also be obtained based on these drawings without paying creative efforts.

FIG. 1 is a schematic structural diagram of a circularly polarized antenna provided in an embodiment of the present application;

FIG. 2 is a diagram illustrating a current distribution on a first arc-shaped radiator when a circularly polarized antenna receives a first frequency signal in a first mode and a second frequency signal in a second mode, provided in an embodiment of the present application;

FIG. 3 is a schematic structural diagram of a circularly polarized antenna provided in another embodiment of the present application;

FIG. 4 is a schematic structural diagram of a circularly polarized antenna provided in another embodiment of the present application;

FIG. 5 is a schematic structural diagram of a circularly polarized antenna provided in another embodiment of the present application; and

FIG. 6 is a diagram illustrating a current distribution on a first arc-shaped radiator and a second arc-shaped radiator when a circularly polarized antenna receives a third frequency signal in the first mode, a fourth frequency signal in the second mode, and a fifth frequency signal in a third mode provided in an embodiment of the present application.

In the figures: 100, first arc-shaped radiator; 101, first radiation portion; 200, feeding point; 300, position determination element; 400, first grounding point; 500, frequency modulation component; 600, second arc-shaped radiator; 700, second grounding point.

### DETAILED DESCRIPTION OF THE EMBODIMENTS

In the following description, for the purpose of explanation rather than limitation, specific details such as specific system structures and technologies are proposed so as to provide a thorough understanding of the embodiments of the present application. However, it should be clear to persons skilled in the art that the present application may also be implemented in other embodiments without these specific details. In other cases, detailed descriptions of well-known systems, devices, circuits, and methods are omitted to avoid unnecessary details that hinder the description of the present application.

It should be understood that, when used in the specification and the appended claims of this application, the term “includes” indicates the presence of the described features, wholes, steps, operations, elements, and/or components, but does not exclude the presence or addition of one or more other features, wholes, steps, operations, elements, components, and/or their collections.

It should also be understood that the term “and/or” used in the specification and appended claims of this application refers to any combination of one or more of the associated listed items and all possible combinations thereof, which include these combinations.

As used in the specification and appended claims of this application, the term “if” may be interpreted as “when . . . ” or “once” or “in response to a determination” or “in response to a detection” depending on the context. Similarly, the phrase “if determined” or “if [described condition or event] is detected” may be interpreted as meaning “once determined” or “in response to determining” or “once [described condition or event] is detected” or “in response to detecting [described condition or event]” according to the context.

In addition, in the description of the specification and appended claims of this application, the terms “first”, “second”, “third”, etc. are only used to distinguish the description and cannot be understood as indicating or implying relative importance.

The description of referring to “one embodiment” or “some embodiments” in the specification of this application means that one or more embodiments of the present application include specific features, structures or characteristics described in combination with the embodiment. Thus, the sentences “in one embodiment”, “in some embodiments”, “in other embodiments”, “in some other embodiments”, etc. appearing in different places in this disclosure do not necessarily refer to the same embodiment, but mean “one or more but not all embodiments”, unless otherwise specifically emphasized in other ways. The terms “including”, “comprising”, “having” and their variations all mean “including but not limited to”, unless otherwise specifically emphasized in other ways.

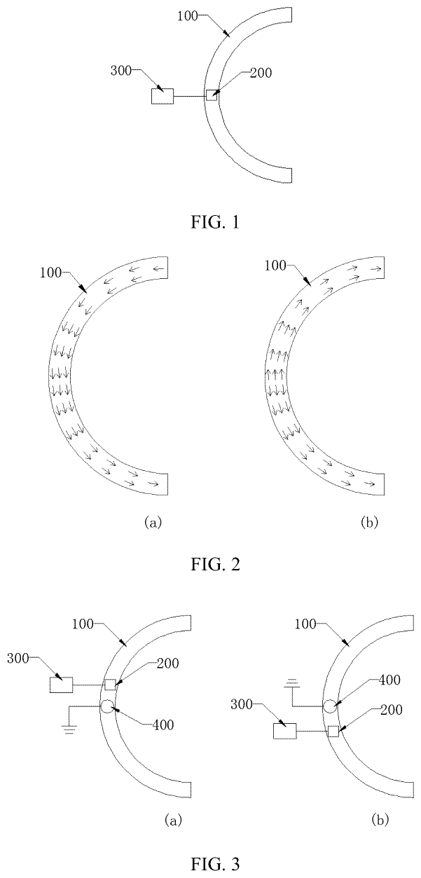

FIG. 1 shows a schematic structural diagram of a circularly polarized antenna provided in an embodiment of the present application. As shown in FIG. 1, the circularly polarized antenna includes a first arc-shaped radiator 100, an arc angle of the first arc-shaped radiator 100 is greater than or equal to 170 degrees and smaller than or equal to 190 degrees, and a feeding point 200 is provided in a central region of the first arc-shaped radiator 100. The feeding point 200 is configured to be electrically connected to a position determination element 300, and the first arc-shaped radiator 100 is configured to receive a first circularly-polarized signal.

Specifically, the are angle of the first arc-shaped radiator 100 is designed to be greater than or equal to 170 degrees and smaller than or equal to 190 degrees, and the feeding point 200 is arranged at the central region of the first arc-shaped radiator 100, so that a current generated by the first arc-shaped radiator 100 when receiving the signal is symmetrical, which makes it easier to ensure that the current generated by the first arc-shaped radiator 100 when receiving the first frequency signal in the first mode and the current generated by the first arc-shaped radiator 100 when receiving the first frequency signal in the second mode are nearly perpendicular to each other with the same amplitude and have a frequency difference of 90 degrees. Thereby, it is prone to determine a signal having a frequency between the first frequency and the second frequency, so that that the current generated by the first arc-shaped radiator 100 when receiving the signal in the first mode and the current generated by the first arc-shaped radiator 100 when receiving the signal in the second mode are nearly perpendicular to each other with the same amplitude and have the frequency difference of 90 degrees. Thus, the first arc-shaped radiator 100 forms a circularly polarized antenna and can receive the first circularly-polarized signal.

The circularly polarized antenna provided in the embodiment of the present application employs the first arc-shaped radiator 100 to form a circularly polarized antenna, eliminating the need to fabricate a complete annular radiator, which reduces a length of the antenna and is conducive to the miniaturization design of the circularly polarized antenna. The first arc-shaped radiator 100 can be flexibly designed in a wearable electronic device, which reduces the design difficulty of the circularly polarized antenna.

It should be noted that the intersection of a perpendicular bisector of a line connecting two ends of the first arc-shaped radiator 100 and the first arc-shaped radiator 100 is a midpoint of the first arc-shaped radiator 100, and the central region of the first arc-shaped radiator 100 includes the midpoint of the first arc-shaped radiator 100 and an area near the midpoint.

FIG. 2 is a diagram showing a current distribution on the first arc-shaped radiator 100 when the circularly polarized antenna provided in an embodiment of the present application receives a first frequency signal in a first mode and receives a second frequency signal in a second mode. Part (a) of FIG. 2 is a current distribution diagram when the first arc-shaped radiator 100 receives the first frequency signal in the first mode, and the current on the first arc-shaped radiator 100 flows vertically up and down. Part (b) of FIG. 2 is a current distribution diagram when the first arc-shaped radiator 100 receives the second frequency signal in the second mode, and the current on the first arc-shaped radiator 100 flows laterally left and right.

It can be seen that there is a signal of a first target frequency, and the first target frequency is between a frequency of the first frequency signal and a frequency of the second frequency signal. The current generated by the first arc-shaped radiator 100 when receiving the signal of the first target frequency in the first mode and the current generated by the first arc-shaped radiator 100 when receiving the signal of the first target frequency in the second mode are perpendicular to each other, have the same amplitude, and differ in frequency by 90 degrees. Thus, the first arc-shaped radiator 100 forms a circularly polarized antenna that can receive a circularly-polarized signal the first target frequency.

Exemplarily, a signal having a frequency between 2.2 GHz and 1.9 GHz (for example, a signal having a frequency of 2.1 GHz) may be determined when the current on the first arc-shaped radiator 100 when the first arc-shaped radiator 100 receives a 2.2 GHz signal in the first mode and the current on the first arc-shaped radiator 100 when the first arc-shaped radiator 100 receives a 1.9 GHz signal in the second mode are perpendicular to each other, have the same amplitude, and have a frequency difference of 90 degrees, thereby, the current on the first arc-shaped radiator 100 when the first arc-shaped radiator 100 receives a 2.1 GHz signal in the first mode and the current on the first arc-shaped radiator 100 when the first arc-shaped radiator 100 receives a 2.1 GHz signal in the second mode are perpendicular to each other, have the same amplitude, and have a frequency difference of 90 degrees. Thus, the first arc-shaped radiator 100 forms a circularly polarized antenna that can receive a circularly-polarized signal having a frequency of 2.1 GHz.

In some embodiments, as shown in FIG. 3, the first arc-shaped radiator 100 is further provided with a first grounding point 400, and the first grounding point 400 is provided in the central region of the first arc-shaped radiator 100. An arc angle between the feeding point 200 and the first grounding point 400 along a circumferential arc of the first arc-shaped radiator is smaller than a preset angle.

Specifically, the first grounding point 400 is provided on the first arc-shaped radiator 100, the first grounding point 400 is also provided in the central region of the first arc-shaped radiator 100, and the arc angle between the feeding point 200 and the first grounding point 400 along a circumferential arc of the first arc-shaped radiator is smaller than the preset angle. That is, a line connecting the first grounding point 400 and a center of a circumference where the first arc-shaped radiator 100 is located is a first line, and a line connecting the feeding point 200 and the center of the circumference where the first arc-shaped radiator 100 is located is a second line, and the first line and the second line form an included angle which is smaller than the preset angle. The preset angle is a relatively small angle, which ensures that the feeding point 200 and the first grounding point 400 are arranged close to each other, which thus can improve an axial ratio of the first radiator when receiving the first circularly-polarized signal, and enhance the performance of the first arc-shaped radiator 100 as a circularly polarized antenna.

It should be noted that the designers can adjust the preset angle according to actual requirements. For example, the preset angle may be configured as an angle being greater than zero and smaller than 45 degrees. The preset angle may also be configured as an angle being greater than zero and smaller than 10 degrees to ensure that the feeding point 200 and the first grounding point 400 are arranged as close as possible, so as to improve the performance of the first arc-shaped radiator 100 when receiving the first circularly-polarized signal.

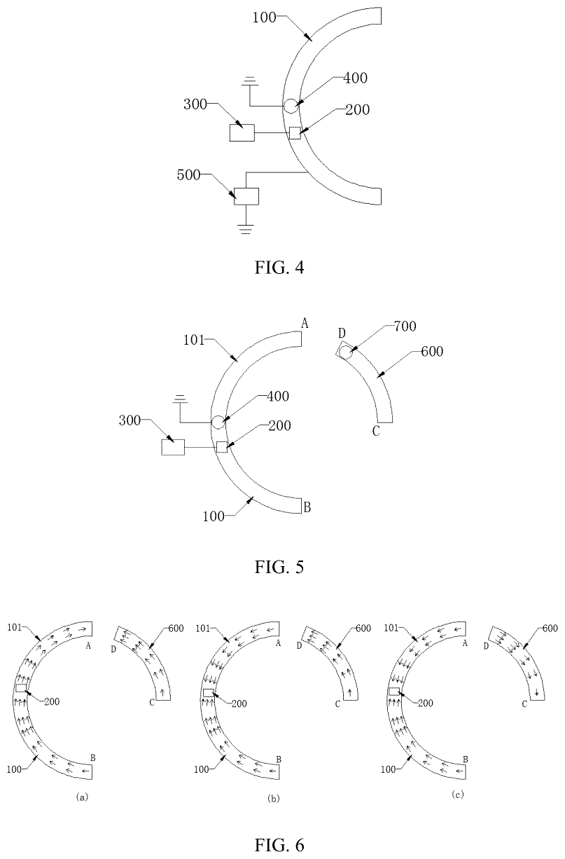

In some embodiments, as shown in FIG. 4, the circularly polarized antenna also includes a frequency modulation component 500, and the frequency modulation component 500 is electrically connected to the first arc-shaped radiator 100.

Specifically, the frequency modulation component 500 may adjust a frequency of the signal received by the first arc-shaped radiator 100, so that the first arc-shaped radiator 100 can receive the first circularly-polarized signal of the first target frequency.

If the frequency modulation component 500 is connected to a current strong zone on the first arc-shaped radiator 100, the frequency modulation component 500 has little impact on the frequency of the signal received by the first arc-shaped radiator 100, that is, the frequency modulation component 500 induces only a slight variation in frequency of the signal received by the first arc-shaped radiator 100. If the frequency modulation component 500 is connected to a current weak zone on the first arc-shaped radiator 100, the impact of the frequency modulation component 500 on the frequency of the signal received by the first arc-shaped radiator 100 is more pronounced, that is, the frequency modulation component 500 induces a significant variation in frequency of the signal received by the first arc-shaped radiator 100.

Thus, by connecting the frequency modulation component 500 at an appropriate position on the first arc-shaped radiator 100, the frequency of the signal received by the first arc-shaped radiator 100 can be adjusted. Ultimately, this enables the first arc-shaped radiator 100 to form a circularly polarized antenna, which can receive the first circularly-polarized signal of the first target frequency.

Exemplarily, the frequency modulation component 500 includes an inductor, a first end of the inductor is electrically connected to the first arc-shaped radiator 100, and a second end of the inductor is grounded; and/or, the frequency modulation component 500 includes a capacitor, a first end of the capacitor is electrically connected to the first arc-shaped radiator 100, and a second end of the capacitor is grounded.

Specifically, when the capacitor is connected to the current strong zone on the first arc-shaped radiator 100, the frequency of the signal received by the first arc-shaped radiator 100 will be slightly reduced. When the capacitor is connected to the current weak zone on the first arc-shaped radiator 100, the frequency of the signal received by the first arc-shaped radiator 100 will be significantly reduced.

When the inductor is connected to the current strong zone on the first arc-shaped radiator 100, the frequency of the signal received by the first arc-shaped radiator 100 is increased slightly. When the inductor is connected to the current weak zone on the first arc-shaped radiator 100, the frequency of the signal received by the first arc-shaped radiator 100 is increased significantly.

Thus, the designers can connect the capacitors and/or inductors at appropriate positions on the first arc-shaped radiator 100 according to actual requirements, which enables the adjustment of the frequency of the signal received by the first arc-shaped radiator 100, and ultimately, the first arc-shaped radiator 100 can receive the first circularly-polarized signal of the first target frequency.

In some embodiments, as shown in FIG. 5, the circularly polarized antenna also includes a second arc-shaped radiator 600. The second arc-shaped radiator 600 and the first arc-shaped radiator 100 are arranged at an interval. The second arc-shaped radiator 600 and the first arc-shaped radiator 100 are located on the same circumference. An arc length between a second end D of the second arc-shaped radiator 600 and a first end A of the first arc-shaped radiator 100 is smaller than an arc length between a first end C of the second arc-shaped radiator 600 and a second end B of the first arc-shaped radiator 100. The second arc-shaped radiator 600 is provided with a second grounding point 700, the second grounding point 700 is arranged at a second end portion of the second arc-shaped radiator 600, and the second end portion of the second arc-shaped radiator 600 includes the second end D of the second arc-shaped radiator 600 and an area near the second end D of the second arc-shaped radiator 600.

Specifically, the first arc-shaped radiator 100 when receiving a second circularly-polarized signal can excite the second arc-shaped radiator 600 to generate a current, thereby, the first arc-shaped radiator 100 and the second arc-shaped radiator 600 form a circularly polarized antenna, which can receive the second circularly-polarized signal.

A line connecting the second end D of the second arc-shaped radiator 600 and a center of the circumference is a third line, and a line connecting the first end A of the first arc-shaped radiator 100 and the center of the circumference is a fourth line. The third line and the fourth line form an included angle which is greater than or equal to 10 degrees and smaller than or equal to 30 degrees. The included angle between the third line and the fourth line may also be configured ranging from 10degrees to 20 degrees. The second arc-shaped radiator 600 is arranged as close as possible to the first arc-shaped radiator 100 to ensure that the first arc-shaped radiator 100 can excite the second arc-shaped radiator 600 when a signal is received by the circularly polarized antenna, to generate a resonant current, so that the first radiation portion 101 on the first arc-shaped radiator 100 and the second arc-shaped radiator 600 can collectively constitute a circularly polarized antenna to receive the second circularly-polarized signal.

Part (a) of FIG. 6 is a diagram showing current distribution on the first arc-shaped radiator 100 and the second arc-shaped radiator 600 when the circularly polarized antenna receives a third frequency signal in the first mode. Part (b) of FIG. 6 is a diagram showing current distribution on the first arc-shaped radiator 100 and the second arc-shaped radiator 600 when the circularly polarized antenna receives a fourth frequency signal in the second mode. Part (c) of FIG. 6 is a diagram showing current distribution on the first arc-shaped radiator 100 and the second arc-shaped radiator 600 when the circularly polarized antenna receives a fifth frequency signal in a third mode.

As can be seen from part (a) and part (b) of FIG. 6, the current of the first arc-shaped radiator 100 when receiving the third frequency signal in the first mode and the current of the first arc-shaped radiator 100 when receiving the fourth frequency signal in the second mode are nearly perpendicular to each other, have the same amplitude, and have a frequency difference of 90 degrees. Thereby, there is a signal of a first target frequency, and the first target frequency is between a frequency of the third frequency signal and a frequency of the fourth frequency signal, so that the current of the first arc-shaped radiator 100 when receiving the signal of the first target frequency in the first mode and the current of the first arc-shaped radiator 100 when receiving the signal of the first target frequency in the second mode are perpendicular to each other, have the same amplitude, and have a frequency difference of 90 degrees. As a result, the first arc-shaped radiator 100 forms a circularly polarized antenna that can receive a circularly polarized signal of the first target frequency.

It can be seen from part (b) and part (c) of FIG. 6 that a current synthesized by the first arc-shaped radiator and the second arc-shaped radiator 600 when the circularly polarized antenna receives a fourth frequency signal in the second mode is a first current, a current synthesized by the first arc-shaped radiator 100 and the second arc-shaped radiator 600 when the circularly polarized antenna receives a fifth frequency signal in the third mode is a second current, and the first current and the second current are nearly perpendicular to each other, have the same amplitude, and differ in frequency by 90 degrees. Thus, there is a signal of a second target frequency, and the second target frequency is between a frequency of the fourth frequency signal and a frequency of the fifth frequency signal. A current synthesized by the first arc-shaped radiator 100 and the second arc-shaped radiator 600 when the circularly polarized antenna receives the signal of the second target frequency in the second mode is a third current, and a current synthesized by the first arc-shaped radiator 100 and the second arc-shaped radiator 600 when the circularly polarized antenna receives the signal of the second target frequency in the third mode is a fourth current. The third current and the fourth current are configured to be perpendicular to each other, have the same amplitude and a frequency difference of 90 degrees. Thus, the first arc-shaped radiator 100 and the second arc-shaped radiator 600 form a circularly polarized antenna that can receive a circularly polarized signal of the second target frequency.

Thus, the circularly polarized antenna formed by the first arc-shaped radiator 100 and the second arc-shaped radiator 600 can receive circularly-polarized signals of two frequencies (a first circularly-polarized signal and a second circularly-polarized signal). In existing wearable electronic devices, a complete circular ring antenna can only receive a circularly-polarized signal of one frequency, while in the present application, two arc-shaped radiators (the first arc-shaped radiator 100 and the second arc-shaped radiator 600) are provided to receive circularly-polarized signals of two frequencies, which increases the number of received circularly-polarized signals. This allows wearable electronic devices to be positioned according to circularly-polarized signals of different frequencies. When a circularly-polarized signal of one frequency cannot be used, the wearable electronic device can use another circularly-polarized signal for positioning, thereby improving the stability of the positioning function of the wearable electronic device.

In some embodiments, as shown in FIG. 6, the second arc-shaped radiator 600 and the first radiation portion 101 on the first arc-shaped radiator 100 are configured to receive a second circularly-polarized signal. Here, the first radiation portion 101 includes a radiator between the feeding point 200 and the first end A on the first arc-shaped radiator 100.

Specifically, it can be seen from part (b) and part (c) in FIG. 6 that a current synthesized by the first radiation portion 101 and the second arc-shaped radiator 600 when the first radiation portion 101 receives the fourth frequency signal in the second mode is a fifth current, a current synthesized by the first radiation portion 101 and the second arc-shaped radiator 600 when the first radiation portion 101 receives the fifth frequency signal in the third mode is a sixth current, and the fifth current and the sixth current are nearly perpendicular to each other, have the same amplitude, and differ in frequency by 90 degrees. Thereby, there is a signal of a second target frequency, and the second target frequency is between the frequency of the fourth frequency signal and the frequency of the fifth frequency signal. A current synthesized by the first radiation portion 101 and the second arc-shaped radiator 600 when the circularly polarized antenna receives the signal of the second target frequency in the second mode is a seventh current, and a current synthesized by the first radiation portion 101 and the second arc-shaped radiator 600 when the circularly polarized antenna receives the signal of the second target frequency in the third mode is an eighth current. The seventh current and the eighth current are perpendicular to each other, have the same amplitude, and differ in frequency by 90 degrees. Thus, the first radiation portion 101 and the second arc-shaped radiator 600 form a circularly polarized antenna that can receive a circularly polarized signal of the second target frequency.

The present application also provides a wearable electronic device, which includes a housing, a position determination element, and the circularly polarized antenna described above. The housing includes a bottom wall and a side wall connected to the bottom wall, the circularly polarized antenna is arranged on the side wall, and the position determination element is coupled with the circularly polarized antenna.

Specifically, the circularly polarized antenna is configured to receive the first circularly-polarized signal and transmit the first circularly-polarized signal to the position determination element, and the position determination element is configured to determine a current geographic location according to the first circularly-polarized signal. Since the circularly polarized antenna applied in the wearable electronic device of the embodiment of the present application can form a circularly polarized antenna by utilizing the first arc-shaped radiator, eliminating the need to fabricate a complete annular radiator, which reduces the length of the antenna and is conducive to the miniaturization design of the circularly polarized antenna. Meanwhile, the first arc-shaped radiator can be flexibly designed in the wearable electronic device, which reduces the design difficulty of the circularly polarized antenna. For the specific working principle, reference may be made to the above description of the circularly polarized antenna, which will not be repeated here.

The foregoing embodiments are only used to illustrate rather than limit the technical schemes of the present application. Although the present application is described in detail with reference to the above embodiments, ordinary technicians in this field should understand that: it is still possible to modify the technical schemes recorded in the above embodiments, or to replace some of the technical features therein by equivalent. These modifications or replacements do not make the essence of the corresponding technical schemes deviate from the spirit and scope of the technical schemes of the embodiments of the present application, and thus should all be included within the protection scope of the present application.

What is claimed is:

1. A circularly polarized antenna, comprising a first arc-shaped radiator, wherein an arc angle of the first arc-shaped radiator is greater than or equal to 170 degrees and smaller than or equal to 190 degrees, a feeding point is provided in a central region of the first arc-shaped radiator, the feeding point is configured in electrical connection with a position determination element, and the first arc-shaped radiator is configured to receive a first circularly-polarized signal.

2. The circularly polarized antenna according to claim 1, wherein the first arc-shaped radiator is further provided with a first grounding point, the first grounding point is provided in the central region of the first arc-shaped radiator, and an arc angle between the feeding point and the first grounding point along a circumferential arc of the first arc-shaped radiator is smaller than a preset angle.

3. The circularly polarized antenna according to claim 2, wherein the preset angle is greater than zero degrees and smaller than 45 degrees.

4. The circularly polarized antenna according to claim 3, wherein the circularly polarized antenna further comprises a frequency modulation component, the frequency modulation component is electrically connected to the first arc-shaped radiator, and the frequency modulation component is configured to adjust a frequency of a signal received by the first arc-shaped radiator, to enable the first arc-shaped radiator to receive the first circularly-polarized signal of a first target frequency.

5. The circularly polarized antenna according to claim 4, wherein the frequency modulation component comprises an inductor, a first end of the inductor is electrically connected to the first arc-shaped radiator, and a second end of the inductor is grounded; and/or,
the frequency modulation component comprises a capacitor, a first end of the capacitor is electrically connected to the first arc-shaped radiator, and a second end of the capacitor is grounded.

6. The circularly polarized antenna according to claim 1, wherein the circularly polarized antenna further comprises a second arc-shaped radiator, the second arc-shaped radiator and the first arc-shaped radiator are arranged at an interval, the second arc-shaped radiator and the first arc-shaped radiator are located on a same circumference, an arc length between a second end of the second arc-shaped radiator and a first end of the first arc-shaped radiator is smaller than an arc length between a first end of the second arc-shaped radiator and a second end of the first arc-shaped radiator, the second arc-shaped radiator is provided with a second grounding point, and the second arc-shaped radiator and the first arc-shaped radiator are configured to receive a second circularly-polarized signal.

7. The circularly polarized antenna according to claim 6, wherein the second arc-shaped radiator and a first radiation portion on the first arc-shaped radiator are configured to receive the second circularly-polarized signal, wherein the first radiation portion comprises a radiator between the feeding point and the first end on the first arc-shaped radiator.

8. The circularly polarized antenna according to claim 6, wherein an arc angle between the first end of the first arc-shaped radiator and the second end of the second arc-shaped radiator along the same circumference is greater than or equal to 10 degrees and smaller than or equal to 30 degrees.

9. The circularly polarized antenna according to claim 6, wherein the second grounding point is arranged at a second end portion of the second arc-shaped radiator.

10. A wearable electronic device, comprising a housing, a position determination element and a circularly polarized antenna,
the circularly polarized antenna comprising a first arc-shaped radiator, wherein an arc angle of the first arc-shaped radiator is greater than or equal to 170 degrees and smaller than or equal to 190 degrees, a feeding point is provided in a central region of the first arc-shaped radiator, the feeding point is configured in electrical connection with the position determination element, and the first arc-shaped radiator is configured to receive a first circularly-polarized signal;
wherein the housing comprises a bottom wall and a side wall connected to the bottom wall, the circularly polarized antenna is arranged on the side wall, and the position determination element is coupled with the circularly polarized antenna; and
the circularly polarized antenna is configured to receive the first circularly-polarized signal and transmit the first circularly-polarized signal to the position determination element, and the position determination element is configured to determine a current geographical location according to the first circularly-polarized signal.

11. The wearable electronic device according to claim 10, wherein the first arc-shaped radiator is further provided with a first grounding point, the first grounding point is provided in the central region of the first arc-shaped radiator, and an arc angle between the feeding point and the first grounding point along a circumferential arc of the first arc-shaped radiator is smaller than a preset angle.

12. The wearable electronic device according to claim 11, wherein the preset angle is greater than zero degrees and smaller than 45 degrees.

13. The wearable electronic device according to claim 12, wherein the circularly polarized antenna further comprises a frequency modulation component, the frequency modulation component is electrically connected to the first arc-shaped radiator, and the frequency modulation component is configured to adjust a frequency of a signal received by the first arc-shaped radiator, to enable the first arc-shaped radiator to receive the first circularly-polarized signal of a first target frequency.

14. The wearable electronic device according to claim 13, wherein the frequency modulation component comprises an inductor, a first end of the inductor is electrically connected to the first arc-shaped radiator, and a second end of the inductor is grounded; and/or,
the frequency modulation component comprises a capacitor, a first end of the capacitor is electrically connected to the first arc-shaped radiator, and a second end of the capacitor is grounded.

15. The wearable electronic device according to claim 10, wherein the circularly polarized antenna further comprises a second arc-shaped radiator, the second arc-shaped radiator and the first arc-shaped radiator are arranged at an interval, the second arc-shaped radiator and the first arc-shaped radiator are located on a same circumference, an arc length between a second end of the second arc-shaped radiator and a first end of the first arc-shaped radiator is smaller than an arc length between a first end of the second arc-shaped radiator and a second end of the first arc-shaped radiator, the second arc-shaped radiator is provided with a second grounding point, and the second arc-shaped radiator and the first arc-shaped radiator are configured to receive a second circularly-polarized signal.

16. The wearable electronic device according to claim 15, wherein the second arc-shaped radiator and a first radiation portion on the first arc-shaped radiator are configured to receive the second circularly-polarized signal, wherein the first radiation portion comprises a radiator between the feeding point and the first end on the first arc-shaped radiator.

17. The wearable electronic device according to claim 15, wherein an arc angle between the first end of the first arc-shaped radiator and the second end of the second arc-shaped radiator along the same circumference is greater than or equal to 10 degrees and smaller than or equal to 30 degrees.

18. The wearable electronic device according to claim 15, wherein the second grounding point is arranged at a second end portion of the second arc-shaped radiator.

19. The circularly polarized antenna according to claim 2, wherein the circularly polarized antenna further comprises a second arc-shaped radiator, the second arc-shaped radiator and the first arc-shaped radiator are arranged at an interval, the second arc-shaped radiator and the first arc-shaped radiator are located on a same circumference, an arc length between a second end of the second arc-shaped radiator and a first end of the first arc-shaped radiator is smaller than an arc length between a first end of the second arc-shaped radiator and a second end of the first arc-shaped radiator, the second arc-shaped radiator is provided with a second grounding point, and the second arc-shaped radiator and the first arc-shaped radiator are configured to receive a second circularly-polarized signal.

20. The circularly polarized antenna according to claim 3, wherein the circularly polarized antenna further comprises a second arc-shaped radiator, the second arc-shaped radiator and the first arc-shaped radiator are arranged at an interval, the second arc-shaped radiator and the first arc-shaped radiator are located on a same circumference, an arc length between a second end of the second arc-shaped radiator and a first end of the first arc-shaped radiator is smaller than an arc length between a first end of the second arc-shaped radiator and a second end of the first arc-shaped radiator, the second arc-shaped radiator is provided with a second grounding point, and the second arc-shaped radiator and the first arc-shaped radiator are configured to receive a second circularly-polarized signal.
